(19) United States
(12) Patent Application Publication
(10) Pub. No.: US 2017/0360103 A1
(43) Pub. Date: Dec. 21, 2017

(54) CONTROL METHOD AND AEROSOL GENERATING DEVICE USING SAME

(71) Applicant: Shenzhen First Union Technology Co., Ltd., Shenzhen City (CN)

(72) Inventors: YONGHAI LI, Shenzhen City (CN); ZHONGLI XU, Shenzhen City (CN); SHUYUN HU, Shenzhen City (CN)

(21) Appl. No.: 15/696,059

(22) Filed: Sep. 5, 2017

(30) Foreign Application Priority Data
Sep. 6, 2016 (CN) 201610802748.2

(51) Int. Cl. A24F 47/00; H05B 1/02; G06F 3/0484

(52) U.S. Cl. CPC A24F 47/008; H05B 1/0297; G06F 3/04842; G06F 3/04847

(57) ABSTRACT

The present disclosure relates to a control method of an aerosol generating device. The control method includes the following steps. In step S100, the aerosol generating device is powered on. In step S200, the aerosol generating device displays a plurality of preset smoking modes and an option of establishing a new smoking mode. In step S300, when a user selects a preset smoking mode, step S400 is executed. In step S400, when the user chooses to execute the preset smoking mode, step S520 is executed. In step S520, the aerosol generating device works in the smoking mode when the user inhales.

### TECHNICAL FIELD

The present invention relates to electronic cigarettes, and particularly to a control method and an aerosol generating device using same.

### BACKGROUND ART

A typical electronic cigarette usually includes only one working mode, and the working mode is preset. Such electronic cigarette cannot satisfy demand (for aerosol) of users in different time periods.

What are needed, therefore, are a control method and an aerosol generating device using same, which can overcome the above shortcomings.

### SUMMARY

The present disclosure relates to a control method of an aerosol generating device. The control method includes the following steps. In step S100, the aerosol generating device is powered on. In step S200, the aerosol generating device displays a plurality of preset smoking modes and an option of establishing a new smoking mode. In step S300, when a user selects a preset smoking mode, step S400 is executed. In step S400, when the user chooses to execute the preset smoking mode, step S520 is executed. In step S520, the aerosol generating device works in the smoking mode when the user inhales.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a flow chart in a custom mode of an aerosol generating device according to an embodiment.

FIG. 2 is a side view of an electronic cigarette, including a power supply.

FIG. 3 is a cross-sectional view of the power supply of FIG. 2.

FIG. 4 is a schematic view showing working modes stored in a memorizing unit.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Several definitions that apply throughout this disclosure will now be presented.

The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

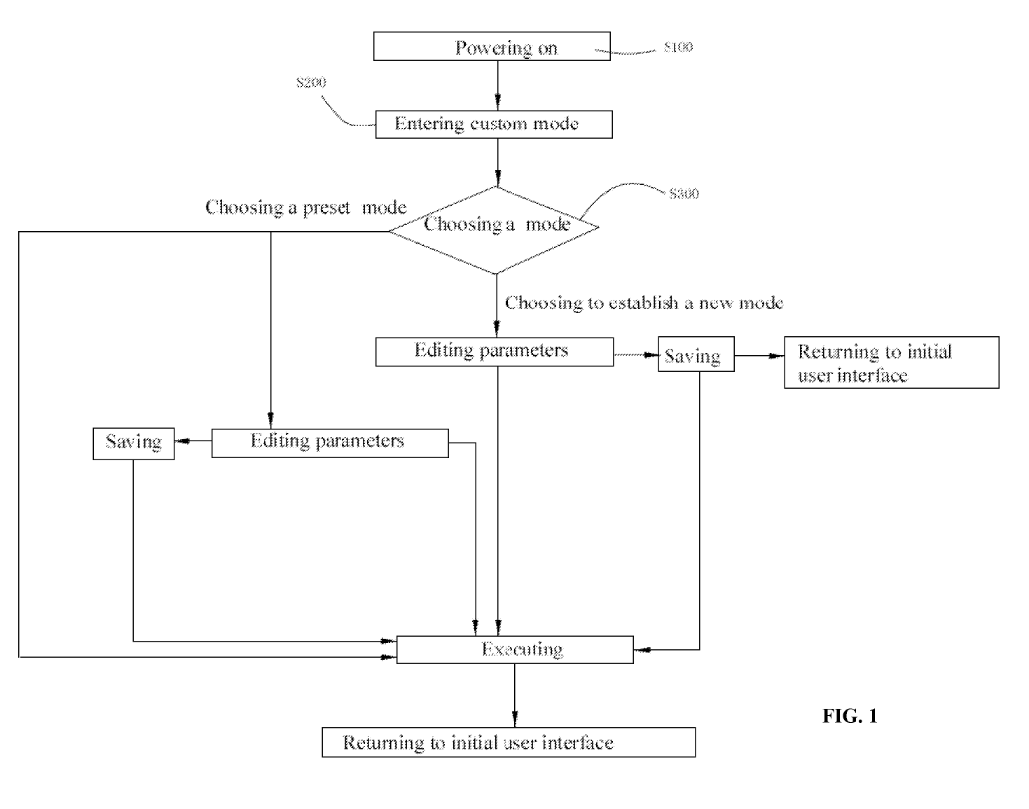

Referring to FIG. 1, a flowchart of a control method of the aerosol generating device is shown.

In step S100, the aerosol generating device is powered on.

In step S200, the user of the aerosol generating device accesses a custom mode by a user interface. A display of the aerosol generating device displays a plurality of smoking modes stored in a memorizer and an option of establishing a new mode.

In step S300, the user chooses a corresponding mode via the user interface. If the user chooses one of the modes stored in the memorizer, the step S400 is executed. If the user chooses the option of setting up a new smoking mode, the step S500 is executed.

In step S400, if the user chooses one of the modes, the aerosol generating device works in the selected mode; if the user chooses to edit one of the modes, the user can edit the mode, and the step S500 is executed.

In step S500, the user edits smoking parameters via the user interface. After finishing editing, if the user chooses to save, the step S510 is executed; if the user chooses to run the edited mode, the step S520 is executed.

In step S510, the smoking mode is saved, and the display will return to an initial user interface automatically in two minutes. The saved mode may be a new smoking mode, or an edited smoking mode.

In step S520, the aerosol generating device works in the selected mode, and the display returns to the initial user interface automatically after two minutes.

In the present embodiment, the aerosol generating device forms aerosol by heating tobacco substance. The smoking parameters in step S500 may include at least one of a heating temperature, a heating frequency, a heating time, and a heating power. In detail, when heating tobacco liquid, a highest temperature is controlled to 280 Celsius degrees; when heating solid tobacco substance, the highest temperature is controlled to 350 Celsius degrees. The heating time may be a time duration every time when the user inhales the aerosol. The configuration of the heating power is configured (i.e., structured and arranged) for adjusting the heating temperature of the aerosol generating device.

In step S510, the smoking mode set by the user is sent to a memorizing unit in a form of commands, and is then saved in the memorizing unit. In this process, if the user does not operate for a certain time period, the display will return to the initial user interface.

In other embodiments, the control method may further include a step of deleting the preset smoking mode in the custom mode, a step of exiting the custom mode, or a step of returning to a previous step.

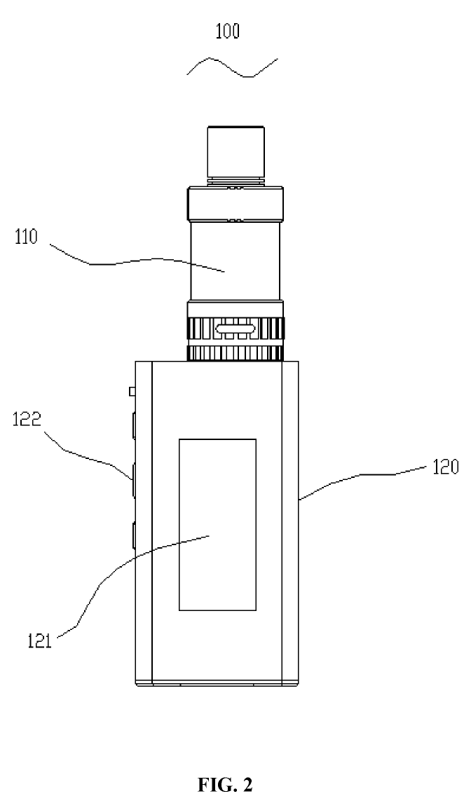

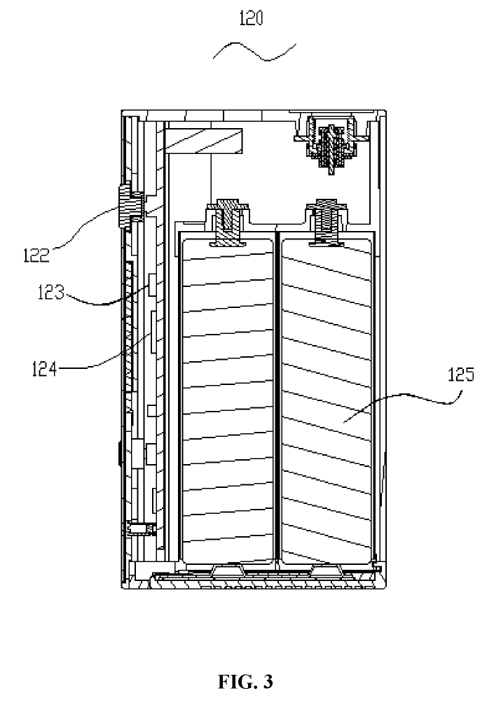

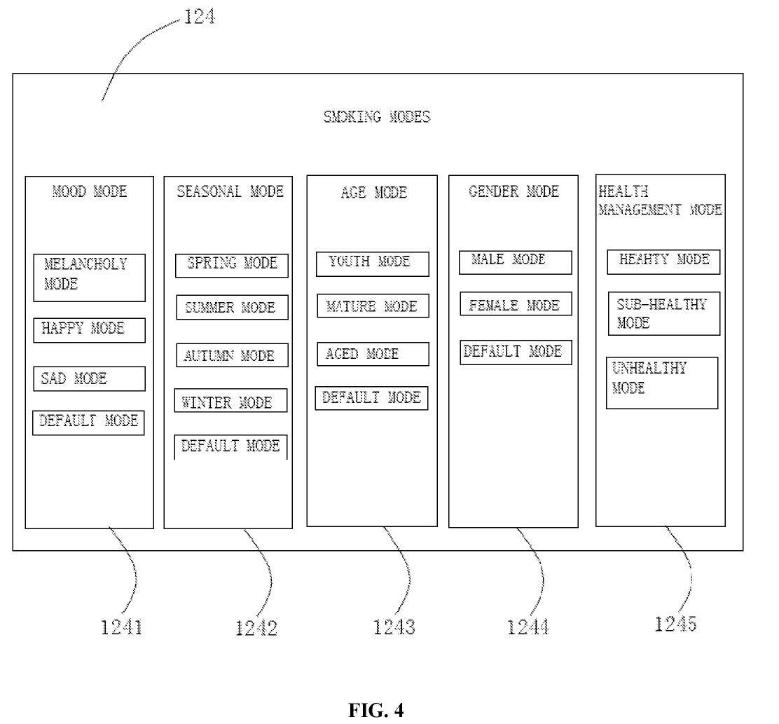

Referring to FIGS. 2-4, the aerosol generating device 100 includes an atomizer 110 and a power supply 120. The atomizer 110 includes tobacco substance and a component configured for generating aerosol from the tobacco substance. The power supply 120 includes a display 121, an operation panel 122, a controller 123, a memorizing unit 124, and a power module 125. The memorizing unit 124 is configured for storing a plurality of smoking modes. These smoking modes may include a mood mode 1241, a seasonal mode 1242, an age mode 1243, a gender mode 1244, and a health management mode 1245.

In detail, the mood mode may include a melancholy mode, a happy mode, a sad mode, and a default mode. In the melancholy mode, the operating power is in an approximate range from 15 Watts to 80 Watts; in the happy mode, the operating power is in an approximate range from 5 Watts to 15 Watts; in the sad mode, the operating power is in an approximate range from 3 Watts to 8 Watts; in the default mode, the operating power is not limited.

The seasonal mode may include a spring mode, a summer mode, an autumn mode, a winter mode, and a default mode. In the spring mode, the operating power is in an approximate range from 15 Watts to 80 Watts; in the summer mode, the operating power is in an approximate range from 5 Watts to 50 Watts; in the autumn mode, the operating power is in an approximate range from 5 Watts to 35 Watts; in the winter mode, the operating power is in an approximate range from 15 Watts to 120 Watts; in the default mode, the operating power is not limited.

The age mode 1243 may include a youth mode, a mature mode, an aged mode, and a default mode. In the youth mode, the operating power is not limited; the mature mode, the operating power is in an approximate range from 5 Watts to 50 Watts; in the aged mode, the operating power is in an approximate range from 5 Watts to 35 Watts.

The gender mode may include a male mode, a female mode, and a default mode. In the male mode, the operating power is in an approximate range from 5 Watts to 120 Watts; in the female mode, the operating power is in an approximate range from 3 Watts to 35 Watts; in the default mode, the operating power is not limited.

The health management mode 1245 may include a healthy mode, a sub-healthy mode, and an unhealthy mode. In the healthy mode, a nicotine content of the tobacco substance is not limited; in the sub-healthy mode, the nicotine content of the tobacco substance is in an approximate range from 0 mg/L to 6 mg/L; in the unhealthy mode, the nicotine content of the tobacco substance is 0 mg/L.

The operation panel 122 includes a plurality of buttons, for example, selecting buttons, a power switch, and so on. A new smoking mode may be set up via the operation panel 122, and the existing smoking mode may be edited via the operation panel 122. The display 121 is configured for displaying a working status of the aerosol generating device 100.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A control method of an aerosol generating device, the control method comprising:
in step S100, powering on the aerosol generating device;
in step S200, entering a custom mode, and displaying a plurality of preset smoking modes and an option of establishing a new smoking mode;
in step S300, when a user selects a preset smoking mode, step S400 being executed, when the user chooses the option of establishing a new smoking mode, step S500 being executed;
in step S400, when the user chooses to execute the preset smoking mode, step S520 being executed, when the user chooses to edit the preset smoking mode, step S500 being executed;
in step S500, the user editing smoking parameters of the preset smoking mode, when the user chooses to save the smoking parameters, the step S510 being executed, when the user chooses to run the aerosol generating device, the step S520 being executed;
in step S510, the aerosol generating device saving the smoking mode; and
in step S520, the aerosol generating device working in the smoking mode when the user inhales.

2. The control method according to claim 1, wherein the smoking mode set by the user is sent to a memorizing unit in a form of commands, and is then saved in the memorizing unit.

3. The control method according to claim 1, further comprising a step of deleting a preset smoking mode in the custom mode.

4. The control method according to claim 1, further comprising a step of exiting the custom mode.

5. The control method according to claim 1, further comprising a step of returning to a previous step.

6. The control method according to claim 1, wherein the aerosol generating device forms aerosol by heating tobacco substance.

7. The control method according to claim 6, wherein the smoking parameters comprise at least one of a heating temperature, a heating frequency, a heating time, and a heating power.

8. The control method according to claim 1, further comprising a step of returning to an initial user interface after the step S510 or S520.

9. An aerosol generating device, comprising:
an atomizer;
an operation panel;
a display;
a controller;
a memorizing unit; and
a power supply;
wherein the aerosol generating device is controlled by using the control method according to claim 1.
